(19) United States
(12) Patent Application Publication
(10) Pub. No.: US 2009/0180514 A1
(43) Pub. Date: Jul. 16, 2009

(54) TRANSFORMER AND A METHOD OF MONITORING AN OPERATION PROPERTY OF THE TRANSFORMER

(75) Inventor: Kevin Anderson, Elk Grove, CA (US)

Correspondence Address: GRAYBEAL JACKSON LLP, 155 - 108TH AVENUE NE, SUITE 350, BELLEVUE, WA, 98004-5973, US

(73) Assignee: CHK GridSense Pty Ltd, Meadowbank (AU)

(21) Appl. No.: 12/350,842

(22) Filed: Jan. 8, 2009

(30) Foreign Application Priority Data
Jan. 10, 2008 (AU) 2008900112

(51) Int. Cl. G01N 25/00; H01F 27/10; H01F 27/12

(52) U.S. Cl. 374/54; 336/58

(57) ABSTRACT

The present disclosure provides a transformer comprising, a transformer core and a tank portion arranged to contain a cooling fluid for absorbing thermal energy from the transformer core. The transformer also comprises a radiator portion which is in fluidal communication with the tank portion and for radiation of at least a portion of the thermal energy absorbed by the cooling fluid. A first temperature sensor is arranged to provide an output that is dependent on a local temperature at the radiator portion. A second temperature sensor is arranged to provide an output that is dependent on a local temperature at another portion of the transformer. The transformer is arranged so that the outputs of the first and second temperature sensors relative to each other are indicative of a level of the cooling fluid or are indicative of a thermal property different from that expected given a power being transformed by the transformer.

### PRIORITY CLAIM

The present application claims the benefit of Australian Patent Application Serial No. 2008900112, filed Jan. 10, 2008, which application is incorporated herein by reference in its entirety.

### TECHNICAL FIELD

The present invention broadly relates to a transformer and a method of monitoring an operation property of the transformer.

### BACKGROUND

A high power transformer develops a significant amount of thermal energy and requires cooling for satisfactory operation. Such a transformer typically comprises cooling oil that absorbs the thermal energy, which is then radiated to the environment at a radiator portion of the transformer.

The transformer comprises a tank portion for containing the cooling oil and it is important to maintain the level of the cooling oil at a prescribed level as otherwise the cooling may be insufficient. Monitoring the level of oil within the transformer tank typically involves using a low-density flotation device that is floating on the cooling oil. The floatation device is coupled to an end of a rotating arm that pivots when the oil level moves, which is indicated by an external mechanical gauge.

However, typically only very large power transformers are equipped with such an arrangement for monitoring the oil level. Smaller power transformers, for example smaller power transformers that are arranged for installation below ground level where gauges are not visible, often do not comprise such arrangements and it is not possible to monitor the oil level.

Further, the demand for cost reduction also often inhibits the inclusion of arrangements for monitoring the oil level. In addition, if such arrangements are to be retro-fitted, it is necessary to take the transformer out of service and dismantle the transformer to access the interior of the tank portion. The cost and inconvenience is often significant.

There is a need for technological advancement.

### SUMMARY

The present invention provides in a first aspect a transformer comprising:

a transformer core;

a tank portion arranged to contain a cooling fluid for absorbing thermal energy from the transformer core;

a radiator portion which is in fluidal communication with the tank portion and for radiation of at least a portion of the thermal energy absorbed by the cooling fluid;

a first temperature sensor being arranged to provide an output that is dependent on a local temperature at the radiator portion; and

a second temperature sensor being arranged to provide an output that is dependent on a local temperature at another portion of the transformer;

wherein the transformer is arranged so that the outputs of the first and second temperature sensors relative to each other are indicative of a level of the cooling fluid.

The first and second temperature sensors may be positioned at interior portions of the transformer, but typically are positioned at exterior portions of the transformer. The first temperature sensor may be positioned at a wall of the radiator portion and the second temperature sensor may be positioned at a wall of the tank portion. The first temperature sensor typically is arranged to provide an output that is dependent on a local temperature at the top radiator portion.

The transformer typically has a prescribed level for the cooling fluid in the tank portion. The transformer may comprise a first opening for directing the cooling fluid from the tank portion to the radiator portion and a second opening for directing the cooling fluid from the radiator portion back to the tank portion.

In one specific embodiment the first opening is positioned at a level that is in use located in the proximity of the prescribed level for the cooling fluid such that a sufficient drop in the level of the cooling fluid prevents flowing of the cooling fluid from the tank portion into the radiator portion. In this embodiment the second temperature sensor typically is located at the tank portion at a level that is in the proximity of the prescribed level of the cooling fluid and the first temperature sensor typically is located at the radiator portion at approximately the same level. If the level of the cooling fluid drops in the tank portion so that flowing of cooling fluid through the first opening is prevented, the radiator portion typically experiences a significant reduction in temperature. A difference in the outputs of the first and second temperature sensors typically is relatively large and comparison of the outputs enables detection of the drop in cooling fluid level in a relatively easy manner.

The transformer may be arranged so that a warning signal is initiated when a drop in the level of the cooling fluid below a predetermined threshold level is detected.

If the cooling fluid ceases to enter the radiator portion, the temperature of the transformer core will typically increase which may lead to operational problems or failure and may decrease the life span of the transformer. The transformer in accordance with an embodiment of the present invention allows monitoring of the level of the cooling fluid in a relatively easy manner and consequently reduces the risk of such increase in temperature and the associated problems.

Embodiments of the present invention have further significant practical advantages. In contrast to typical known arrangements for monitoring the level of a cooling fluid, the transformer in accordance with embodiments of the present invention typically does not require mechanical components for monitoring the level of the cooling fluid. Mechanical parts would be subject to wear and ultimately failure, which could result in a drop in cooling fluid level not being detected. Further, the temperature sensors may be fitted externally and therefore may be retrofitted in a relatively easy and inexpensive manner.

In one specific embodiment the transformer is arranged to obtain information relating to an operation property other than the level of the cooling fluid, such as an amount of thermal energy transferred by the cooling fluid from the tank portion to the radiator portion and at least partially dissipated by the radiator portion. For example, the transformer may be arranged, typically with the aid of a computer, to compare quantities associated with the outputs of the temperature sensors with predetermined expected quantities such as those expected for normal operation of the transformer.

During normal operation of the transformer an amount of thermal energy that that is generated by the transformer core dependents largely on electrical energy passing through the transformer. The thermal energy is transferred from the tank portion to the radiator portion by the cooling fluid. As the cooling fluid flows through the radiator portion, thermal energy is irradiated resulting in a reduction in temperature of the cooling fluid. A difference between the outputs of the first and second temperature sensors is indicative of the thermal energy generated by the transformer.

The transformer may comprise a computer that is arranged to read the measured outputs of the temperature sensors and provide information indicative of an operation property from the measured temperatures. The computer may be arranged to compare a quantity indicative of an operation property with an expected predetermined quantity. The computer may also be arranged to calculate a quantity that is associated with an amount of thermal energy generated by the transformer core and/or a quantity that is associated with a level of the cooling fluid. Further, the computer may be arranged to generate an alarm condition if a difference between expected predetermined outputs and measured outputs is above a threshold value.

The cooling fluid may be of any suitable type, but typically is an oil or coolant.

The first and/or the second temperature sensors typically are resistive temperature sensors that indicate a change in temperature by a change in electrical resistance.

The present invention provides in a second aspect a method of monitoring an operation property of a transformer, the method comprising:

detecting a quantity indicative of a change in temperature at least two different positions of the transformer, the positions being selected so that a drop in a level of the cooling fluid affects the local temperature at the selected positions differently; and

determining the operation property from the detected quantities.

In one specific embodiment of the present invention the method comprises detecting a quantity indicative of a change in temperature at a tank portion of the transformer and at a radiator portion of the transformer.

The quantities may be measured in the proximity of a prescribed level of the cooling fluid of the transformer.

The step of determining the operation property from the detected quantities may comprise comparing the detected quantities with each other and determining the level of the cooling fluid or an amount of transferred thermal energy from a difference between the quantities detected at the at least two different positions.

Each quantity indicative of a change in temperature may for example be an output of a temperature sensor, such as a resistive temperature sensor. The cooling fluid may be oil or coolant.

The method may also comprise comparing the detected quantities with predetermined expected quantities associated with a level of power transformed by the transformer. The operation property may for example be a level of a cooling fluid or an amount of thermal energy that is transferred by the cooling fluid.

The method may comprise reading the measured outputs of the temperature sensors using a computer. The method may also comprise comparing the measured outputs with expected predetermined outputs associated with the operation condition using the computer to characterize the operation property, such as a level of the cooling fluid or an amount of transferred thermal energy. The computer may further be arranged to generate an alarm condition, if a difference between the expected predetermined outputs and measured outputs is above a threshold value.

The present invention provides in a third aspect a transformer comprising:

a transformer core;

a tank portion arranged to contain a cooling fluid for absorbing thermal energy from the transformer core;

a radiator portion which is in fluidal communication with the tank portion and for radiation of at least a portion of the thermal energy absorbed by the cooling fluid; and

a temperature sensor arranged to measure a local temperature at a portion in proximity of a prescribed cooling fluid level of the transformer;

wherein the transformer is arranged so that the measured local temperature is indicative of a level of the cooling fluid relative to the prescribed level of the cooling fluid.

In one specific embodiment the transformer is arranged to characterize an operation property, such as a level of the cooling fluid or an amount of thermal energy transferred by the cooling fluid from the tank portion to the radiator portion and at least partially dissipated by the radiator portion. For example, the transformer may be arranged, typically with the aid of a computer, to compare the outputs of the temperature sensors with predetermined expected outputs associated with a level of power transformed by the transformer.

The computer may be arranged to generate an alarm condition when a difference between the predetermined expected and measured outputs is above a threshold value.

The invention will be more fully understood from the following description of specific embodiments of the invention. The description is provided with reference to the accompanying drawings.

### BRIEF DESCRIPTION OF THE DRAWINGS

FIG. 1 shows a transformer according to a specific embodiment of the present invention.

FIG. 2 shows a flow chart illustrating a method of measuring a level of a cooling fluid in a transformer according to a specific embodiment of the present invention.

FIG. 3 shows a graph illustrating the relationship between oil level within a transformer tank and oil temperature.

### DETAILED DESCRIPTION

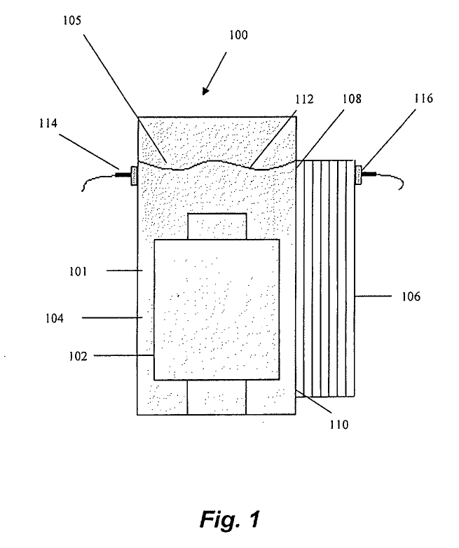

Referring to initially to FIG. 1, a transformer according to a specific embodiment of the present invention is now described. The transformer 100 comprises a transformer core 102 which is positioned within a housing 101. The housing 101 provides a tank 104 for a cooling fluid 105.

The transformer core 102 develops in use thermal energy, which is absorbed by the cooling fluid 105. In this example, the cooling fluid 105 is oil. The transformer 100 further comprises a radiator 106 which is in fluidal communication with the tank 104.

The transformer 100 is arranged so that the oil flows from the tank 104 to the radiator 106 through a first opening which is a top radiator inlet 108. The radiator 106 absorbs the thermal energy from the oil 105 and radiates the absorbed thermal energy to the environment. The cooled oil is then returned into the tank 104 via a radiator outlet 110.

The transformer 100 is designed such that, at a minimum temperature which is in the order of 20 degrees Celsius, the oil level in the tank 104 is located at the bottom of the radiator inlet 108. This is a minimum prescribed oil level 112 and a rise of the oil level above that level, which may for example be effected by an increase in temperature of the oil, will result in a flow of the oil 105 into the radiator 106. However, if the oil level drops below the minimum prescribed level 112, for example because of an oil leak or otherwise lost oil, the flow of the oil 105 into the radiator 106 will be inhibited.

In a specific embodiment of the invention a temperature sensor 114 is positioned at an exterior wall portion of the transformer 100 at a level just below the minimum prescribed oil level 112. A further temperature sensor 116 is positioned at an external wall of the radiator 106. In this specific embodiment the temperature sensors are resistance temperature detectors.

The measured temperature is dependent on the level of the oil 105, the power that is transformed by the transformer 100 and the ambient temperature. A drop in the oil level below the minimum prescribed level 112 will prevent oil flow through the radiator inlet 108 into radiator 106 resulting in the oil 105 in the radiator 106 cooling dramatically. This will create a significant difference in the temperatures detected by the temperature sensor 114 and the temperature sensor 116. Detection of that difference, for example by comparing output signals form the temperature sensors 114 and 116, will signal that there has been a drop in oil level below the minimum prescribed level 112.

The transformer 100 may also be arranged so that a warning signal is generated when the oil level dropped below the prescribed minimum level 112.

Additionally or alternatively outputs of the temperature sensors 114 and 116 may be compared with predetermined expected outputs associated with a level of power transformed by the transformer 100. The radiator 106 irradiates thermal energy received from the oil 105 and the radiator 106 has a temperature different to that of the tank 104. The difference in temperature is dependent on design parameters of the transformer 100, but also indicative of thermal energy generated in the transformer core 102. Consequently, comparing the outputs of the temperature sensors 114 and 116 provides information that is indicative of an operation condition of the transformer 100.

Comparing the outputs of the temperature sensors 114 and 116 is performed with the aid of a suitable computer (not shown) comprising a suitable computer software program and arranged to receive information on the electrical power that is transformed and on the ambient temperature. The computer compares a quantity associated with the measured outputs with predetermined quantities expected for a normal operation condition taking into account an amount of electrical power that is transformed by the transformer 100 and the ambient temperature. The computer is arranged to calculate the developed thermal energy for a given transformer design geometry and then calculate the level of the oil in the tank 104. The computer is arranged to generate an alarm condition if a difference between the expected predetermined outputs and measured outputs is above a threshold value. The transformer 100 also comprises a display (not shown) for displaying information associated with the determined oil level.

Although in the above-described specific embodiment two temperature sensors are employed, a person skilled in the art will appreciate that in further variations more than two temperature sensors may be used.

Further, the transformer 100 may only comprise one temperature sensor, such as either the temperature sensor 114 or the temperature sensor 116. As indicated above, a drop in oil level sufficient so that the oil 105 does no longer flow through the radiator inlet 108 will typically effect a cooling of the radiator 106, which would be detectable by the temperature sensor 116. Consequently, even without the temperature sensor 114, the drop in the oil level will be detectable. Alternatively, if the oil level drops below the level of the temperature sensor 114, the wall portion at the location of the temperature sensor 114 would also experience a local reduction in temperature, which would be detectable by the temperature sensor 114. Consequently, even without the temperature sensor 116, the drop in oil level will be detectable.

Even though the transformer may in this example comprise only one temperature sensor, it is possible to determine the level of the oil 105 quantitatively. For example, the computer, arranged to receive information on the power that is transformed and on the ambient temperature, may use the output from a single temperature sensor (for example, the temperature sensor 114 or the temperature sensor 116) to calculate the developed thermal energy for a given transformer design and then calculate the level of the oil in the tank 104.

However, the transformer 100 comprising both the temperature sensors 114 and 116 has the significant advantage that the detection of such a drop in oil level is further facilitated as the difference in the outputs of the temperature sensors 114 and 116 typically is relatively large and easily detectable. Further, the use of at least two temperature sensors has the added advantage that malfunction of one of the temperature sensors can be detected. For example, if the temperature sensor 116 senses a very high temperature, it is expected that the temperature sensor 114 would also sense a relatively high temperature. If, however, the temperature sensor 114 senses a very low temperature, it is probable that one of the detectors is defective.

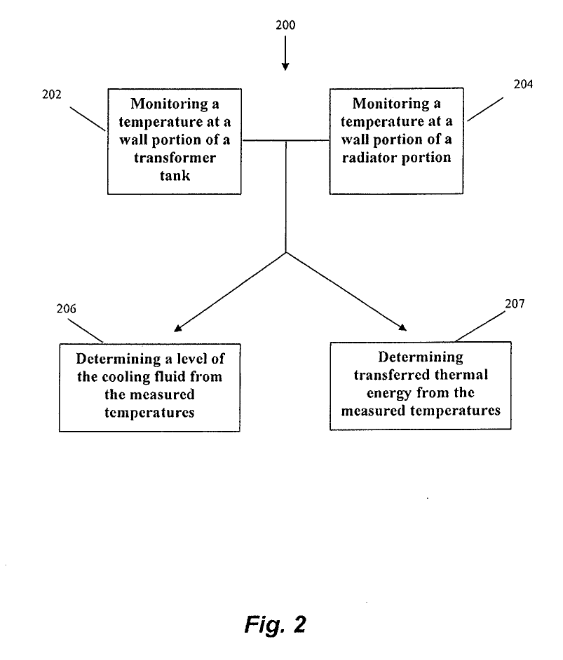

Referring now to FIG. 2, a method of monitoring an operation property, such as a level of a cooling fluid in a transformer or an amount of thermal energy, according to a specific embodiment of the present invention is now described. The method 200 includes step 202 of monitoring a temperature at a wall portion of a transformer tank, such as the transformer tank 104 shown in FIG. 1.

Further, the method 200 comprises step 204 of monitoring a temperature at a wall of a radiator portion, such as the radiator portion 106 shown in FIG. 1. In this embodiment, the temperatures are monitored at a cooling fluid level that is in the proximity of a prescribed cooling fluid level of the transformer.

The method 200 further comprises step 206 of determining a level of the cooling fluid from the measured temperatures. The method further comprises step 207 of determining transferred thermal energy from the measured temperatures. The steps 206 and 207 may comprise using a suitable computer software routine.

In addition, the method 200 may comprise the step of generating a warning signal if the determined cooling fluid level is below a predetermined threshold level.

Data analysis and processing associated with the method 200 is performed using a computer. The outputs from the temperature sensors 114 and 116 are received by the computer together with information on the electrical power, that is transformed, and on the ambient temperature. The computer compares quantities associated with the measured outputs with predetermined quantities expected for a normal operation condition taking into account an amount of electrical power that is transformed by the transformer 100 and possibly, but not necessarily, the ambient temperature. The computer then calculates the developed thermal energy for a given transformer design and also calculates the level of the oil in the tank. The computer generates an alarm condition if a difference between the expected predetermined outputs and measured outputs is above a threshold value.

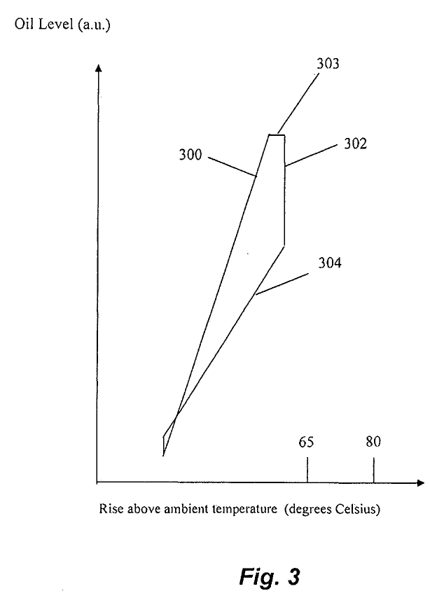

FIG. 3 shows plots 300, 302, 303 and 304, which illustrate the relationship between oil level within a transformer tank and oil temperature for the transformer 100 shown in FIG. 1.

The plot 304 indicates an increasing temperature of the oil having a level in the proximity of the temperature sensor 114. In this area, heat is added to the system by the core at a relatively linear rate with respect to elevation from the floor.

The plot 302 also relates to the temperature of the oil measured by temperature sensor 114. The plot 302 shows a largely constant temperature as the oil level decreases across the location of the temperature sensor 114. The temperature is largely constant because on thermal energy is added and little heat escapes.

Plot 303 relates to the temperature drop from the tank wall to the radiator furthest removed from the transformer where sensor 116 is located. A small, but definite temperature drop will be sensed to determine if the oil level is adequate to allow for oil flow to the end radiator and if cooling efficiency is as expected when compared with the calculated temperature difference between the two sensors.

The plot 300 shows the temperature detected by the temperature sensor 116. The plot shows a decrease in temperature of the radiator oil from top to bottom as the oil cools in the radiator, condenses and sinks. As the heat transfer coefficient between the oil and the walls of the radiators typically is relatively low and the walls typically have very little thermal mass, the thermal energy from the oil is quickly transferred to the environment adjacent to the external radiator walls.

It is to be appreciated that the present invention may be provided in many different forms.

The scope of the present devices, systems and methods, etc., includes both means plus function and step plus function concepts. However, the claims are not to be interpreted as indicating a “means plus function” relationship unless the word “means” is specifically recited in a claim, and are to be interpreted as indicating a “means plus function” relationship where the word “means” is specifically recited in a claim. Similarly, the claims are not to be interpreted as indicating a “step plus function” relationship unless the word “step” is specifically recited in a claim, and are to be interpreted as indicating a “step plus function” relationship where the word “step” is specifically recited in a claim.

From the foregoing, it will be appreciated that, although specific embodiments have been discussed herein for purposes of illustration, various modifications may be made without deviating from the spirit and scope of the discussion herein. Accordingly, the systems and methods, etc., include such modifications as well as all permutations and combinations of the subject matter set forth herein and are not limited except as by the appended claims or other claim having adequate support in the discussion herein.

1. A transformer comprising:
a transformer core;
a tank portion arranged to contain a cooling fluid for absorbing thermal energy from the transformer core;
a radiator portion which is in fluidal communication with the tank portion and for radiation of at least a portion of the thermal energy absorbed by the cooling fluid;
a first temperature sensor being arranged to provide an output that is dependent on a local temperature at the radiator portion; and
a second temperature sensor being arranged to provide an output that is dependent on a local temperature at another portion of the transformer;
wherein the transformer is arranged so that the outputs of the first and second temperature sensors relative to each other are indicative of a level of the cooling fluid.

2. The transformer of claim 1 wherein the first and second temperature sensors are positioned at exterior portions of the transformer.

3. The transformer of claim 1 wherein the first temperature sensor is positioned at a wall of the radiator portion and the second temperature sensor is positioned at a wall of the tank portion.

4. The transformer of claim 1 wherein the transformer has a prescribed level for the cooling fluid in the tank portion, the transformer comprising a first opening for directing the cooling fluid from the tank portion to the radiator portion and a second opening for directing the cooling fluid from the radiator portion back to the tank portion.

5. The transformer of claim 4 wherein the first opening is positioned at a level that is in use located in the proximity of the prescribed level for the cooling fluid such that a sufficient drop in the level of the cooling fluid prevents flowing of the cooling fluid from the tank portion into the radiator portion.

6. The transformer of claim 5 wherein the second temperature sensor is located at the tank portion at a level that is in the proximity of the prescribed level of the cooling fluid and the first temperature sensor is located at the radiator portion at approximately the same level.

7. The transformer of claim 1 wherein the transformer is arranged so that a warning signal is initiated when a drop in the level of the cooling fluid below a predetermined threshold level is detected.

8. The transformer of claim 1 wherein the cooling fluid is an oil.

9. The transformer of claim 1 wherein the first and the second temperature sensors are resistive temperature sensors that indicate a change in temperature by a change in electrical resistance.

10. The transformer of claim 1 comprising a computer arranged to read the measured outputs of the temperature sensors and provide information indicative of an operation property from the measured temperatures.

11. The transformer of claim 10 arranged to compare the information indicative of an operation property with information associated with an expected predetermined operation property.

12. The transformer of claim 10 wherein the computer is arranged to calculate a quantity that is associated with an amount of thermal energy generated by the transformer core.

13. The transformer of claim 10 wherein the computer is arranged to calculate a quantity that is associated with a level of the cooling fluid.

14. A method of monitoring an operation property of a transformer, the method comprising:
detecting a quantity indicative of a change in temperature at least two different positions of the transformer, the positions being selected so that a drop in a level of the cooling fluid affects the local temperature at the selected positions differently; and
determining the operation property of from the detected quantities.

15. The method of claim 14 wherein the operation property comprises a level of a cooling fluid.

16. The method of claim 14 wherein the operation property comprises an amount of thermal energy that is transferred by a cooling fluid.

17. The method of claim 14 wherein the step of determining the operation property from the detected quantities comprises comparing the detected quantities with each other and determining the level of the cooling fluid or an amount of transferred thermal energy from a difference between the quantities detected at the at least two different positions.

18. The method of claim 14 comprising comparing the detected quantities with expected predetermined expected quantities.

19. The method of claim 18 comprising generating an alarm condition if a difference between the expected predetermined quantities and measured quantities is above a threshold value.

20. The method of claim 14 comprising detecting a quantity indicative of a change in temperature at a tank portion of the transformer and at a radiator portion of the transformer and wherein the quantities are measured in the proximity of a prescribed level of the cooling fluid of the transformer.

21. The method of claim 14 wherein each quantity indicative of a change in temperature is an output of a temperature sensor.

22. A transformer comprising:
a transformer core;
a tank portion arranged to contain a cooling fluid for absorbing thermal energy from the transformer core;
a radiator portion which is in fluidal communication with the tank portion and for radiation of at least a portion of the thermal energy absorbed by the cooling fluid; and
a temperature sensor arranged to measure a local temperature at a portion in proximity of a prescribed cooling fluid level of the transformer;
wherein the transformer is arranged so that the measured local temperature is indicative of a level of the cooling fluid relative to the prescribed level of the cooling fluid.
